(19) United States
(12) Patent Application Publication
(10) Pub. No.: US 2023/0170118 A1
(43) Pub. Date: Jun. 1, 2023

(54) COIL COMPONENT

(71) Applicant: SAMSUNG ELECTRO-MECHANICS CO., LTD., Suwon-si (KR)

(72) Inventor: Jun Ho Yoon, Suwon-si (KR)

(73) Assignee: SAMSUNG ELECTRO-MECHANICS CO., LTD., Suwon-si (KR)

(21) Appl. No.: 17/981,854

(22) Filed: Nov. 7, 2022

(30) Foreign Application Priority Data
Nov. 26, 2021 (KR) 10-2021-0165733

(51) Int. Cl. H01F 5/04; H01F 5/06

(52) U.S. Cl. CPC H01F 5/04; H01F 5/06; H01F 2005/043

(57) ABSTRACT

A coil component includes: a body having first and second surfaces opposing each other; and a coil portion embedded within the body, wherein the coil portion includes first and second coil patterns, a first lead-out portion and a first dummy lead-out portion respectively extending from the first coil pattern, and respectively exposed to the first and second surfaces of the body, while being spaced apart from each other, and a second lead-out portion and a second dummy lead-out portion respectively extending from the second coil pattern, and respectively exposed to the first and second surfaces of the body, while being spaced apart from each other.

### CROSS-REFERENCE TO RELATED APPLICATION(S)

The present application claims the benefit of priority to Korean Patent Application No. 10-2021-0165733 filed on Nov. 26, 2021 in the Korean Intellectual Property Office, the disclosure of which is incorporated herein by reference in its entirety.

### TECHNICAL FIELD

The present disclosure relates to a coil component.

### BACKGROUND

An inductor, a coil component, is a representative passive electronic component used in an electronic device together with a resistor and a capacitor.

When a body of the coil component has almost the same length and width as each other, it may be difficult to specify to which surface of the body a lead-out portion of a coil portion is exposed, and as a result, it may be difficult to specify a surface of the body on which an external electrode is to be formed.

In addition, two types of electrodes, i.e. L-type and B-type electrodes, have been each manufactured as bottom electrode of the inductor in a prior art. However, a lot of processes may be required to manufacture the bottom electrode when using a method of the prior art, in which a terminal of the coil component is exposed in a width-thickness (WT) direction.

### SUMMARY

An aspect of the present disclosure may provide a coil component which may be easily manufactured.

According to an aspect of the present disclosure, a coil component may include: a body having first and second surfaces opposing each other in a thickness direction; and a coil portion embedded within the body, wherein the coil portion includes first and second coil patterns, a first lead-out portion and a first dummy lead-out portion respectively extending from the first coil pattern in the thickness direction, and respectively exposed to the first and second surfaces of the body, while being spaced apart from each other, and a second lead-out portion and a second dummy lead-out portion respectively extending from the second coil pattern, and respectively exposed to the first and second surfaces of the body, while being spaced apart from each other.

According to another aspect of the present disclosure, a coil component may include: a body having first and second surfaces opposing each other in a thickness direction and third and fourth surfaces connecting the first and second surfaces of the body to each other and opposing each other in a length direction; and a coil portion disposed within the body, wherein the coil portion includes first and second coil patterns, a first lead-out portion extending from the first coil pattern in the thickness direction and exposed to each of the first and third surfaces of the body, and a second lead-out portion extending from the second coil pattern in the thickness direction and exposed to each of the first and fourth surfaces of the body.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is a perspective view schematically illustrating a coil component according to an exemplary embodiment of the present disclosure;

FIG. 2 is a transparent view schematically illustrating the coil component according to an exemplary embodiment viewed from a direction A of FIG. 1;

FIGS. 3 through 5 are transparent views each schematically illustrating a coil component according to a modified example viewed from the direction A of FIG. 1;

FIG. 6 is a perspective view schematically illustrating a coil component according to another exemplary embodiment of the present disclosure; and

FIG. 7 is a transparent view schematically illustrating the coil component according to another exemplary embodiment viewed from a direction A of FIG. 6.

### DETAILED DESCRIPTION

Hereinafter, exemplary embodiments in the present disclosure will now be described in detail with reference to the accompanying drawings.

In the drawings, an L direction refers to a first direction or a length direction, a W direction refers to a second direction or a width direction, and a T direction refers to a third direction or a thickness direction.

Hereinafter, a coil component according to exemplary embodiments of the present disclosure will be described in detail with reference to the accompanying drawings. In describing exemplary embodiments of the present disclosure with reference to the accompanying drawings, components that are the same as or correspond to each other will be denoted by the same reference numerals, and overlapping descriptions thereof will be omitted.

Various kinds of electronic components may be used in an electronic device, and various kinds of coil components may be appropriately used between these electronic components depending on their purposes in order to remove noise or the like.

That is, the coil component used in the electronic device may be a power inductor, high frequency (HF) inductor, a general bead, a bead for a high frequency (GHz), a common mode filter or the like.

### Exemplary Embodiment

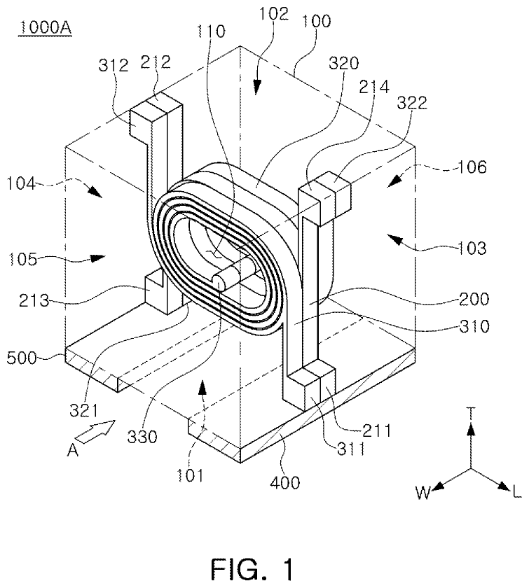

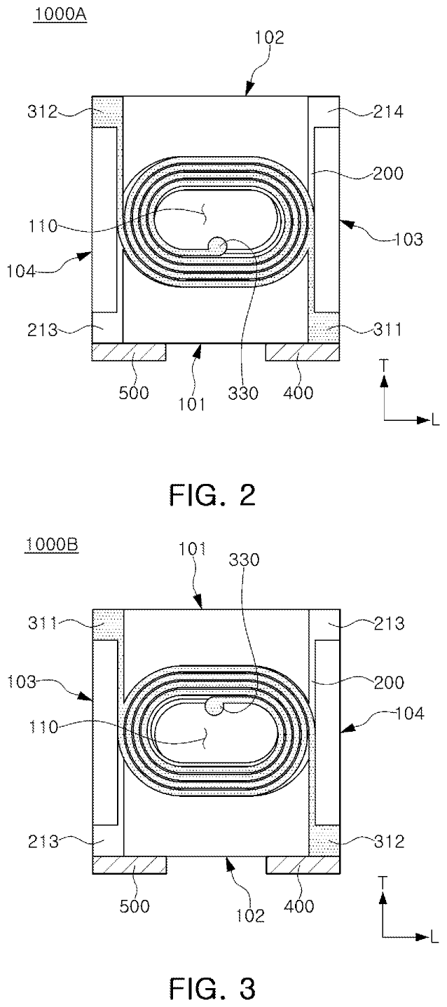

FIG. 1 is a perspective view schematically illustrating a coil component according to an exemplary embodiment of the present disclosure. FIG. 2 is a transparent view schematically illustrating the coil component according to an exemplary embodiment viewed from a direction A of FIG. 1.

Referring to FIGS. 1 and 2, a coil component 1000A according to an exemplary embodiment of the present disclosure may include a body 100, an internal insulating layer 200, a coil portion 300 and first and second external electrodes 400 and 500.

The body 100 may form an exterior of the coil component 1000A according to the present exemplary embodiment. The body 100 may generally have a hexahedral shape.

Hereinafter, the description exemplary describes the present on a premise that the body 100 has the hexahedral shape. However, this description does not exclude a coil component including a body formed in a shape other than the hexahedral shape from a scope of the present disclosure.

Referring to FIGS. 1 and 2, the body 100 may have a first surface 101 and a second surface 102 opposing each other in the thickness (T) direction, a third surface 103 and a fourth surface 104 opposing each other in the length (L) direction, and a fifth surface 105 and a sixth surface 106 opposing each other in the width (W) direction. Each of the third to sixth surfaces 103, 104, 105 and 106 of the body 100 may correspond to a wall surface of the body 100, connecting the first surface 101 and the second surface 102 of the body 100 to each other. As shown in the drawings, the third and fourth surfaces 103 and 104 opposing each other in the length (L) direction and the fifth and sixth surfaces 105 and 106 opposing each other in the width (W) direction may connect the first and second surfaces 101 and 102 of the body 100 to each other.

For example, the body 100 may have a length (L) and a thickness (T) the same as each other. However, the scope of the present disclosure is not limited to the above-described size of the body 100. That is, even when the body 100 has the length (L) and the thickness (T) different from each other, the body 100 may have almost the same length (L) and thickness (T) as each other. In this case, it may be difficult to specify the length (L) direction and thickness (T) direction of the body 100 only by the appearance of body 100, which falls within the scope of the present disclosure. Meanwhile, the above-described size of the body 100 may have a numerical value that does not reflect a process error or the like, and an actual size of the body 100 may thus have a different value from the above-described value due to the process error or the like.

The body 100 may include a magnetic material and a resin. In detail, the body 100 may be formed by stacking at least one magnetic composite sheet including the resin and the magnetic materials dispersed in the resin. However, the body 100 may have a structure other than a structure in which the magnetic materials are dispersed in the resin. For example, the body 100 may comprise the magnetic material such as ferrite.

The magnetic material may be ferrite powders or metal magnetic powders.

The ferrite powders may include, for example, at least one of a spinel type ferrite such as Mg—Zn-based ferrite, Mn—Zn-based ferrite, Mn—Mg-based ferrite, Cu—Zn-based ferrite, Mg—Mn—Sr-based ferrite or Ni—Zn-based ferrite; a hexagonal type ferrite such as Ba—Zn-based ferrite, Ba—Mg-based ferrite, Ba—Ni-based ferrite, Ba—Co-based ferrite or Ba—Ni—Co-based ferrite; or a garnet type ferrite such as Y-based ferrite or Li-based ferrite.

The metal magnetic powders may include one or more selected from the group consisting of iron (Fe), silicon (Si), chromium (Cr), cobalt (Co), molybdenum (Mo), aluminum (Al), niobium (Nb), copper (Cu) or nickel (Ni). For example, the metal magnetic powders may be one or more of pure iron powders, Fe—Si-based alloy powders, Fe—Si—Al-based alloy powders, Fe—Ni-based alloy powders, Fe—Ni—Mo-based alloy powders, Fe—Ni—Mo—Cu-based alloy powders, Fe—Co-based alloy powders, Fe—Ni—Co-based alloy powders, Fe—Cr-based alloy powders, Fe—Cr—Si-based alloy powders, Fe—Si—Cu—Nb-based alloy powders, Fe—Ni—Cr-based alloy powders or Fe—Cr—Al-based alloy powders.

The metal magnetic powders may be amorphous or crystalline. For example, the metal magnetic powders may include Fe—Si—B—Cr based amorphous alloy powders, and are not necessarily limited thereto.

The ferrite and the metal magnetic powders may have average diameters of about 0.1 μm to 30 μm, respectively, and are not limited thereto.

The body 100 may include two or more types of magnetic materials dispersed in the resin. Here, different types of magnetic materials may indicate that the magnetic materials dispersed in the resin are distinguished from each other by any one of an average diameter, a composition, crystallinity and a shape.

The resin may include epoxy, polyimide, liquid crystal polymer (LCP) or the like, or mixtures thereof, and is not limited thereto.

The body 100 may include a core 110 passing through the coil portion 300 and the internal insulating layer 200, described below. The core 110 may be formed by filling a through hole of the coil portion 300 with the magnetic composite sheet, and is not limited thereto. The coil portion 300 applied to the present exemplary embodiment may have an axis parallel to the width (W) direction of the body 100, and thus be formed as one coil generating a magnetic field from the inside of the body 100 in the width (W) direction of the body 100.

The internal insulating layer 200 may be embedded within the body 100. The coil portion 300 described below may be disposed on the internal insulating layer 200. That is, the internal insulating layer 200 may support the coil portion 300.

The internal insulating layer 200 may comprise an insulating material including a thermosetting insulating resin such as an epoxy resin, a thermoplastic insulating resin such as polyimide or a photosensitive insulating resin, or an insulating material impregnated with a reinforcing material such as glass fiber or inorganic filler in the insulating resin. For example, the internal insulating layer 200 may comprise an insulating material such as prepreg, an Ajinomoto Build-up Film (ABF), FR-4, a bismaleimide triazine (BT) resin, a photo imagable dielectric (PID) or the like, and is not limited thereto.

The inorganic filler may comprise one or more materials selected from the group consisting of silica (SiO₂), alumina (Al₂O₃), silicon carbide (SiC), barium sulfate (BaSO₄), talc, clay, mica powders, aluminum hydroxide (AlOH₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃) and calcium zirconate (CaZrO₃).

When formed of the insulating material including the reinforcing material, the internal insulating layer 200 can provide higher rigidity. When internal insulating layer 200 is formed of an insulating material that does not include the glass fiber, it may be advantageous in reducing an overall width of the coil component 1000A according to the present exemplary embodiment. When the internal insulating layer 200 comprises the insulating material including the photosensitive insulating resin, it is possible to reduce the number of processes, which may be advantageous in reducing a production cost and forming a fine via.

That is, the coil portion 300 described below, which is applied to the present exemplary embodiment, may include a first coil pattern 310, a second coil pattern 320, a first lead-out portion 311, and a first dummy lead-out portion 312, a second lead-out portion 321 and a second dummy lead-out portion 322. Accordingly, the internal insulating layer 200 may include a support portion disposed adjacent to a center of the body 100 to support the first and second coil patterns 310 and 320, and first to fourth protrusions 211, 212, 213 and 214 each extending from the support portion to be exposed to at least one of the first to fourth surfaces 101, 102, 103 and 104 of the body 100, and each supporting the first lead-out portion 311, the first dummy lead-out portion 312, the second lead-out portion 321 or the second dummy lead-out portion 322. Referring to FIGS. 1 and 2, the internal insulating layer 200 may have one surface facing toward the fifth surface 105 of the body 100 and the other surface facing toward the sixth surface 106. Therefore, the internal insulating layer 200 may be disposed in the body such that the one surface and the other surface are parallel to the fifth and sixth surfaces of the body 105 and 106, respectively. The first coil pattern 310 may be disposed on the one surface of the internal insulating layer 200, and the second coil pattern 320 may be disposed on the other surface of the internal insulating layer 200. In detail, the first lead-out portion 311 may be disposed on one surface of the first protrusion 211, the first dummy lead-out portion 312 may be disposed on one surface of the second protrusion 212, the second lead-out portion 321 may be disposed on the other surface of the third protrusion 213, and the second dummy lead-out portion 322 may be disposed on the other surface of the fourth protrusion 214. As a result, referring to FIG. 1, the first protrusion 211 and the first lead-out portion 311 may be exposed to the first and third surfaces 101 and 103 of the body 100 together, the second protrusion 212 and the first dummy lead-out portion 312 may be exposed to the second and fourth surfaces 102 and 104 of the body 100 together, the third protrusion 213 and the second lead-out portion 321 may be exposed to the first and fourth surfaces 101 and 104 of the body 100 together, and the fourth protrusion 214 and the second dummy lead-out portion 322 may be exposed to the second and third surfaces 102 and 103 of the body 100 together. As a result, the internal insulating layer 200 may be exposed to the first to fourth surfaces 101, 102, 103 and 104 of the body 100 due to the first to fourth protrusions 211, 212, 213 and 214.

The coil portion 300 may be embedded within the body 100 and disposed on the internal insulating layer 200, thereby exhibiting a characteristic of the coil component. For example, when the coil component 1000A of the present exemplary embodiment is used as the power inductor, the coil portion 300 may serve to store an electric field as the magnetic field to maintain an output voltage, thereby stabilizing power of the electronic device.

That is, the coil portion 300 applied to the present exemplary embodiment may have the axis parallel or substantially parallel to the width (W) direction of the body 100, and thus be formed as one coil generating the magnetic field from the inside of the body 100 in the width (W) direction of the body 100.

The coil portion 300 applied to the present exemplary embodiment may include the first coil pattern 310, the second coil pattern 320, the first lead-out portion 311, the first dummy lead-out portion 312, the second lead-out portion 321, the second dummy lead-out portion 322 and a via 330.

The first coil pattern 310, the internal insulating layer 200 and the second coil pattern 320 may be sequentially stacked in the width (W) direction of the body 100.

Each of the first coil pattern 310 and the second coil pattern 320 may have a flat spiral shape. For example, the first coil pattern 310 may have at least one turn formed on one surface of the internal insulating layer 200 (i.e. surface where the internal insulating layer 200 faces the fifth surface 105 of the body 100, based on FIG. 1) by having the core 110 of the body 100 as an axis. The second coil pattern 320 may have at least one turn formed on the other surface of the internal insulating layer 200 (i.e. surface where the internal insulating layer 200 faces the sixth surface 106 of the body 100, based on FIG. 1) by having the core 110 of the body 100 as an axis. The first and second coil patterns 310 and 320 may be wound in the same direction.

The first lead-out portion 311 and the first dummy lead-out portion 312 may respectively be extended from the first coil pattern 310, and externally exposed from the body 100, while being spaced apart from each other. In detail, the first lead-out portion 311 may be exposed to the first and third surfaces 101 and 103 of the body 100, and the first dummy lead-out portion 312 may be exposed to the second and fourth surfaces 102 and 104 of the body 100. That is, the first lead-out portion 311 and the first dummy lead-out portion 312 may be symmetrically disposed by having the core 110 as an axis. The second lead-out portion 321 and the second dummy lead-out portion 322 may respectively be extended from the second coil pattern 320, and externally exposed from the body 100, while being spaced apart from each other. In detail, the second lead-out portion 321 may be exposed to the first and fourth surfaces 101 and 104 of the body 100, and the second dummy lead-out portion 322 may be exposed to the second and third surfaces 102 and 103 of the body 100. That is, the second lead-out portion 321 and the second dummy lead-out portion 322 may be symmetrically disposed by having the core 110 as an axis. As a result, each of the first and second lead-out portions 311 and 321 and the first and second dummy lead-out portions 312 and 322 of the first and second coil patterns 310 and 320 may be exposed to a boundary between any two surfaces of the first to fourth surfaces 101, 102, 103 and 104 of body 100.

As a result, in the coil component 1000A according to the present exemplary embodiment, the first and second external electrodes 400 and 500 can be more easily connected to the coil portion 300 even without processes of identifying and specifying a surface on which the first and second external electrodes 400 and 500 described below to be formed among the surfaces of the body 100. That is, even when the body 100 has the length and the thickness similar to each other and it is thus difficult to specify the length (L) direction and the thickness (T) direction, the first and second external electrodes 400 and 500 can be connected to the coil portion 300 as long as the first and second external electrodes 400 and 500 are formed on both ends of any one of the first to fourth surfaces 101, 102, 103 and 104 of the body 100. Here, both the ends of any one of the first to fourth surfaces 101, 102, 103 and 104 may refer to both the ends of the body in the length (L) direction or the thickness (T) direction.

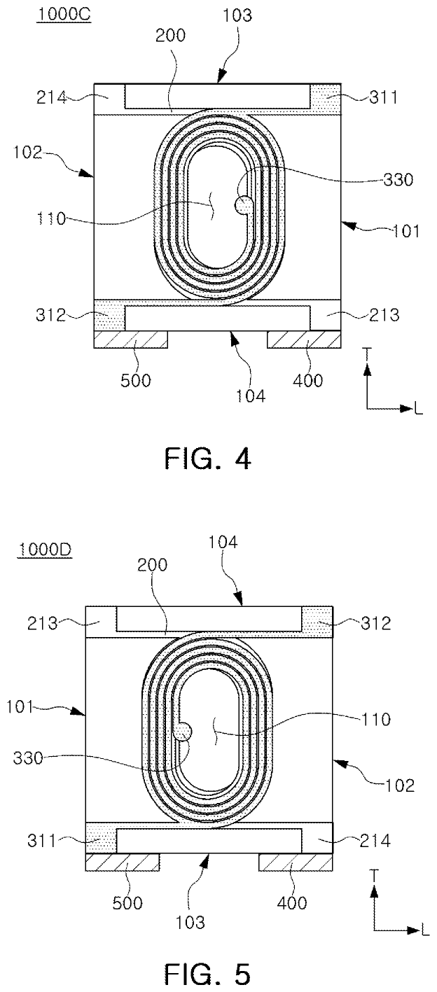

In detail, as shown in FIG. 2, the first and second external electrodes 400 and 500 may be formed on both the ends the first surface 101 of the body 100 in the length (L) direction. In addition, referring to coil components 1000B, 1000C and 1000D described below according to modified examples of FIGS. 3 through 5, the first and second external electrodes 400 and 500 can be easily connected to the coil portion 300 by forming the first and second external electrodes 400 and 500 on both the ends of the second surface 102 of the body 100 in the length (L) direction as shown in FIG. 3, forming the first and second external electrodes 400 and 500 on both the ends of the fourth surface 104 of the body 100 in the thickness (T) direction as shown in FIG. 4, or forming the first and second external electrodes 400 and 500 on both the ends of the third surface 103 of the body 100 in the thickness (T) direction as shown in FIG. 5.

Therefore, the coil component 1000A according to the present exemplary embodiment may not require a separate identification mark used in forming the first and second external electrodes 400 and 500.

The first lead-out portion 311 and the first dummy lead-out portion 312 may be formed together in the same process as the first coil pattern 310 to have no boundary formed therebetween. That is, the first lead-out portion 311, the first dummy lead-out portion 312 and the first coil pattern 310 may be integrally formed with one another. The second lead-out portion 321 and the second dummy lead-out portion 322 may be formed together in the same process as the second coil pattern 320 to have no boundary formed therebetween. That is, the second lead-out portion 321, the second dummy lead-out portion 322 and the second coil pattern 320 may be integrally formed with one another.

In the coil component 1000A according to an exemplary embodiment described with reference to FIGS. 1 and 2, the following areas may be the same as each other: an area of the first lead-out portion 311 exposed to the first and third surfaces 101 and 103 of the body 100, an area of the first dummy lead-out portion 312 exposed to the second and fourth surfaces 102 and 104 of the body 100, an area of second lead-out portion 321 exposed to the first and fourth surfaces 101 and 104 of the body 100, and an area of the second dummy lead-out portion 322 exposed to the third and fourth surfaces 103 and 104 of the body 100. In this case, it is possible to maintain predetermined reliability in the connection between the coil portion 300 and the first and second external electrodes 400 and 500 regardless of whether on which surface the first and second external electrodes 400 and 500 are formed among the first to fourth surfaces 101, 102, 103 and 104 of the body 100.

The via 330 may pass through the internal insulating layer 200 to be in contact with each of the first coil pattern 310 and the second coil pattern 320, thereby electrically connecting the first coil pattern 310 and the second coil pattern 320 to each other. In detail, the via 330 may pass through one region in the support portion of the internal insulating layer 200 described above. As a result, the coil portion 300 applied to the present exemplary embodiment may be formed as one coil generating the magnetic field from the inside of the body 100 in the width (W) direction of the body 100.

That is, a direction in which the via 330 passes through the internal insulating layer 200 may be substantially parallel to the first to fourth surfaces 101, 102, 103 and 104 of the body 100. That is, the coil component 1000A according to an exemplary embodiment of the present disclosure may be a vertically disposed coil component to the first and second surfaces 101 and 102 of the body, and the axis of the coil portion 300 may thus be substantially parallel to the width (W) direction. In addition, the via 330 may pass through the internal insulating layer 200 in the direction substantially parallel to the first to fourth surfaces 101, 102, 103 and 104 of the body 100, which is the surface on which the first and second external electrodes 400 and 500 described below are disposed. In the present disclosure, an expression, “substantially parallel” may refer to a range not only including a “perfectly parallel” case but also including a case where “an error occurs in a manufacturing process.”

The first and second coil patterns 310 and 320 may each have a greater width than a thickness. Here, the thickness of each of the first and second coil patterns 310 and 320 may refer to a length of each of first and second coil patterns 310 and 320 in the width (W) direction, and the width of each of the first and second coil patterns 310 and 320 may refer to a length of each of the first and second coil patterns 310 and 320 in the thickness (T) direction. This shape is because the axis of the coil portion 300 of the present disclosure may be perpendicular to the thickness (T) direction, and thus be substantially parallel to the width (W) direction of the coil component 1000A. That is, each turn of the first and second coil patterns 310 and 320 may have less than one (1) of an aspect ratio (A/R) that is a ratio of the thickness to the width of the coil patterns 310 and 320. Accordingly, the coil component 1000A according to the present exemplary embodiment may have a relatively smaller width, which may be further advantageous in forming an electronic device including the coil component 1000A of the present disclosure to have a relatively smaller width.

At least one of the first coil pattern 310, the second coil pattern 320, the first lead-out portion 311, the first dummy lead-out portion 312, the second lead-out portion 321, the second dummy lead-out portion 32, and the via 330 may include at least one conductive layer.

For example, when the second coil pattern 320, the second lead-out portion 321, the second dummy lead-out portion 322 and the via 330 are formed by plating, the second coil pattern 320, the second lead-out portion 321, and the second dummy lead-out portion 322 and via 330 may each include a seed layer and an electroplating layer. The seed layer may be formed by using an electroplating method or a vapor deposition method such as sputtering. The electroplating layer may have a monolayer or multilayer structure. The electroplating layer having the multilayer structure may be a conformal film in which another electroplating layer covers one electroplating layer, or may be a layer in which another electroplating layer is stacked on only one surface of one electroplating layer. The seed layer of each of the second coil pattern 320, the second lead-out portion 321 and the second dummy lead-out portion 322 and the seed layer of the via 330 may be integrally formed with each other to have no boundary formed therebetween, and are not limited thereto. The seed layer of each of the second coil pattern 320, the second lead-out portion 321 and the second dummy lead-out portion 322 and the seed layer of the via 330 may be integrally formed with each other to have no boundary formed therebetween, and are not limited thereto.

For another example, when the first coil pattern 310 and the second coil pattern 320 are formed separately from each other, and then collectively stacked on the internal insulating layer 200 to form the coil portion 300, the via 330 may include a high-melting-point metal layer and a low-melting-point metal layer having a melting point lower than a melting point of the high-melting-point metal layer. Here, the low-melting-point metal layer may include a solder including lead (Pb) and/or tin (Sn). At least a portion of the low-melting-point metal layer may be melted due to pressure and temperature in the collective stacking, and an Intermetallic compound layer (IMC Layer) may thus be formed on at least one gap between the low-melting-point metal layer and the first coil pattern 310, between the low-melting-point metal layer and the second coil pattern 320, and between the high-melting-point metal layer and the low-melting-point metal layer.

For example, the first coil pattern 310 and the second coil pattern 320 may respectively protrude from the one surface and the other surface of the internal insulating layer 200, based on a direction of FIG. 1. For another example, the second coil pattern 320 may be embedded in the other surface of the internal insulating layer 200 to expose one surface thereof to the other surface of the internal insulating layer 200, and the first coil pattern 310 may protrude from the one surface of the internal insulating layer 200. In this case, a recession portion may be formed in the one surface of the second coil pattern 320, and therefore, the other surface of the internal insulating layer 200 and a lower surface of the second coil pattern 320 may not be disposed on the same plane as each other. For another example, the second coil pattern 320 may be embedded in the other surface of the internal insulating layer 200 to expose the one surface thereof to the other surface of the internal insulating layer 200, and the first coil pattern 310 may be embedded in the one surface of the internal insulating layer 200 to expose the one surface thereof to the one surface of the internal insulating layer 200.

The first coil portion 310, the second coil pattern 320, the first lead-out portion 311, the first dummy lead-out portion 312, the second lead-out portion 321, the second dummy lead-out portion 322 and the via 330 may each comprise a conductive material such as copper (Cu), aluminum (Al), silver (Ag), tin (Sn), gold (Au), nickel (Ni), lead (Pb), titanium (Ti) or alloys thereof, and is not limited thereto.

Referring to FIG. 1, the first and second external electrodes 400 and 500 may be disposed on the first surface 101 of the body 100, while being spaced apart from each other, and connected to the coil portion 300. In detail, the first external electrode 400 may be disposed on the first surface 101 of the body 100 to be connected to the first lead-out portion 311 exposed to the first surface 101. The second external electrode 500 may be disposed on the first surface 101 of the body 100, while being spaced apart from the first external electrode 400, and connected to the second lead-out portion 321 exposed to the first surface 101 of the body 100.

The first external electrode 400 and the second external electrode 500 may be disposed on the first surface 101 of the body 100, while being spaced apart from each other, thereby preventing short-circuit occurring therebetween. In this case, the external electrodes 400 and 500 may be disposed only on the first surface 101 among outer surfaces of the body 100 to reduce an entire volume of the coil component 1000A, and secure a volume of the body 100 by that much, thereby increasing a magnetic flux of the coil and improving the characteristics of the coil component.

The first or second external electrode 400 or 500 may be formed by using the vapor deposition method such as the sputtering, a plating method or a paste printing method.

The first or second external electrode 400 or 500 may comprise the conductive material such as copper (Cu), aluminum (Al), silver (Ag), tin (Sn), gold (Au), nickel (Ni), lead (Pb), titanium (Ti) or alloys thereof, and is not limited thereto. The first and second external electrodes 400 and 500 may each have a monolayer or multilayer structure. When having the latter structure, the first and second external electrodes 400 and 500 may each include a conductive resin layer including conductive powders and the resin, a nickel plating layer including nickel (Ni), and a tin plating layer including tin (Sn), and are not limited thereto.

The first and second external electrodes 400 and 500 may electrically connect the coil component 1000A to a printed circuit board or the like when the coil component 1000A according to the present exemplary embodiment is mounted on the printed circuit board or the like. For example, the coil component 1000A according to an exemplary embodiment can be easily connected to the printed circuit board or the like by being mounted thereon after the first surface 101 of the body 100 is disposed to face the printed circuit board.

That is, although not shown, the coil component 1000A according to the present exemplary embodiment may include an insulating film formed along surfaces of the first coil pattern 310, the second coil pattern 320, the first lead-out portion 311, the first dummy lead-out portion 312, the second lead-out portion 321, the second the dummy lead-out portion 322 and the internal insulating layer 200. The insulating film may be provided to protect the first coil pattern 310, the second coil pattern 320, the first lead-out portion 311, the first dummy lead-out portion 312, the second lead-out portion 321 and the second dummy lead-out portion 322, and insulate the same from the body 100. Accordingly, the insulating film may include a well-known insulating material such as parylene. The insulating material included in the insulating film is not particularly limited, and may be any insulating material. The insulating film may be formed by using a method such as the vapor deposition, and is not limited thereto. The insulating film may be formed by stacking the insulating material such as the insulating film on each of two surfaces of the internal insulating layer 200 on which the first and second coil patterns 310 and 320 are formed. However, the above-described insulating film may be omitted from the present exemplary embodiment if necessary for design.

That is, although not shown, at least one of the first coil pattern 310 and the second coil pattern 320 may be formed of a plurality of layers. For example, the coil portion 300 may have a structure in which the plurality of first coil patterns 310 are formed, and another first coil pattern is stacked on one first coil pattern. In this case, an additional insulating layer may be disposed between the plurality of first coil patterns 310, and a connection via passing through the additional insulating layer may be formed in the additional insulating layer to connect the adjacent first coil patterns to each other.

### Modified Example

FIGS. 3 through 5 are transparent views each schematically illustrating a coil component according to a modified example viewed from the direction A of FIG. 1.

The coil components 1000B, 1000C and 1000D according to the modified examples of FIGS. 3 through 5 may have the first and second external electrodes 400 and 500 formed on different positions, when compared to the coil component 1000A according to an exemplary embodiment. Therefore, each description of the coil components 1000B, 1000C and 1000D according to the following modified examples only describes a component having a difference compared to that of the coil component 1000A according to an exemplary embodiment. For the other overlapping components, the of the coil component 1000A according to an exemplary embodiment may be equally applied as it is.

Referring to the coil components 1000B, 1000C and 1000D according to the modified examples of FIGS. 3 through 5, the first and second external electrodes 400 and 500 can be easily connected to the coil portion 300 by forming the first and second external electrodes 400 and 500 on both the ends of the second surface 102 of the body 100 in the length (L) direction as shown in FIG. 3, forming the first and second external electrodes 400 and 500 on both the ends of the fourth surface 104 of the body 100 in the thickness (T) direction as shown in FIG. 4, or forming the first and second external electrodes 400 and 500 on both the ends of the third surface 103 of the body 100 in the thickness (T) direction as shown in FIG. 5.

That is, referring to the transparent views of the coil components 1000A, 1000B, 1000C and 1000D of FIGS. 2 through 5, the present disclose shows a structure in which at least one of the first lead-out portion 311 and the first dummy lead-out portion 312 is exposed to the first to fourth surfaces 101, 102, 103 and 104 of the body 100, and at least one of the second lead-out portion 321 and the second dummy lead-out portion 322 is exposed to the first to fourth surfaces 101, 102, 103 and 104 of the body 100.

Through the above structure, when the coil component includes the first and second external electrodes 400 and 500 formed in a shape of a bottom electrode, it is possible to omit the process of selecting a specific surface among the first to fourth surfaces 101, 102, 103 and 104, and form the first and second external electrodes 400 and 500 on any of the first to fourth surfaces 101, 102, 103 and 104 to be electrically connected to the lead-out portions 311 and 321 or the dummy lead-out portions 312 and 322.

That is, two lead-out portions of the first lead-out portion 311, the first dummy lead-out portion 312, the second lead-out portion 321 and the second dummy lead-out portion 322 may be connected to one of the first and second external electrodes 400 and 500, and the rest two lead-out portions may be exposed to the outer surface of the body 100 and may not be connected to the external electrode.

That is, in the coil components 1000B, 1000C and 1000D according to the modified examples, the first and second dummy lead-out portions 312 and 322 may also be connected to the first and second external electrodes 400 and 500. That is, in the coil component 1000A according to an exemplary embodiment, only the first and second lead-out portions 311 and 321 may respectively be connected to the first and second external electrodes 400 and 500. Meanwhile, in the coil components 1000B, 1000C and 1000D according to the modified examples, the first and second lead-out portions 311 and 321 may not be connected to the external electrodes, and only the first and second dummy lead-out portions 312 and 322 may be connected to the external electrodes (i.e. structure of FIG. 3).

In addition, one lead-out portion connected to the first and second external electrodes 400 and 500 may be one of the first and second lead-out portions 311 and 321, and the other lead-out portion may be one of the first and second dummy lead-out portions 312 and 322 (i.e. structure of FIG. 4 or 5).

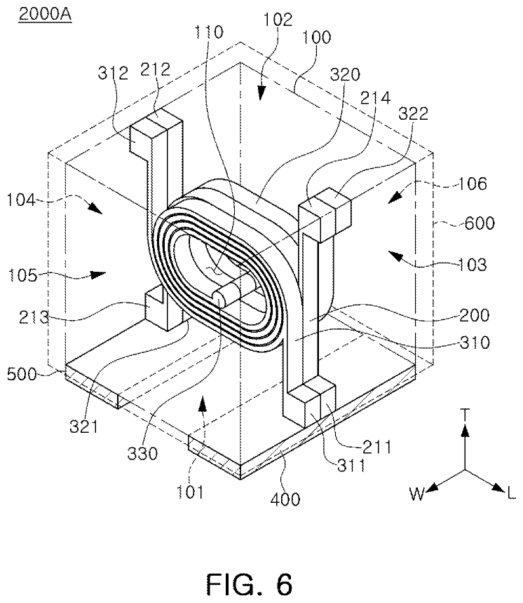

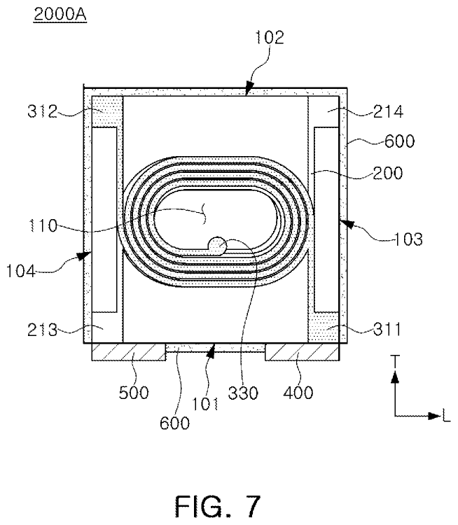

FIG. 6 is a perspective view schematically illustrating a coil component 2000A according to another exemplary embodiment of the present disclosure; and FIG. 7 is a transparent view schematically illustrating the coil component according to another exemplary embodiment viewed from a direction A of FIG. 6.

Referring to FIGS. 1 and 6, the coil component 2000A according to another exemplary embodiment may further include an external insulating layer 600 when compared to the coil component 1000A according to an exemplary embodiment of the present disclosure. Therefore, in describing the present exemplary embodiment, the description describes only the external insulating layer 600. For the other components of the present exemplary embodiment, the description for those in an exemplary embodiment of the present disclosure may be applied as it is.

Referring to FIG. 6, the external insulating layer 600 may surround the body 100 to cover the outer surface of the body 100. Here, openings respectively exposing the first and second lead-out portions 311 and 321 may be formed in the external insulating layer 600 to connect the first and second external electrodes 400 and 500 to the coil portion 300. In detail, the external insulating layer 600 may include a first external insulating layer disposed on the first surface 101 of the body 100, a second external insulating layer disposed on the second surface 102 of the body 100, a third external insulating layer disposed on the third surface 103 of the body 100, a fourth external insulating layer disposed on the fourth surface 104 of the body 100, a fifth external insulating layer disposed on the fifth surface 105 of the body 100, and a sixth external insulating layer disposed on the sixth surface 106 of the body 100. The first to sixth external insulating layers may be integrally formed with each other by using a dipping method. Alternatively, at least two or more of the first to sixth external insulating layers may form a boundary therebetween. The first to sixth external insulating layers may each be formed by applying an insulating paste to the surface of the body 100, or by stacking the insulating film on the surface of the body 100 and then curing the same.

The first external insulating layer formed on the first surface 101 among the external insulating layers 600 may be used as a mask when forming the first and second external electrodes 400 and 500 on the body 100.

The external insulating layer 600 may include a thermoplastic resin such as polystyrenes, vinyl acetates, polyesters, polyethylenes, polypropylenes, polyamides, rubbers or acryls, a thermosetting resin such as phenols, epoxies, urethanes, melamines or alkyds, a photosensitive resin or an insulating resin such as parylene.

The opening may be formed by exposing at least a portion of the first surface 101 of the body 100 after forming the external insulating layer 600 to entirely cover the first to sixth surfaces 101, 102, 103, 104, 105 and 106 of the body 100. In detail, the opening may expose each of two ends of the first surface 101 of the body 100 in the length (L) direction.

That is, although not shown, when the coil components 1000B, 1000C and 1000D according to the modified examples each include the external insulating layer 600, the first and second external electrodes 400 and 500 may be formed on one of the second to fourth surfaces 102, 103 and 104 instead of the first surface 101, as shown in FIGS. 3 through 5, and the opening may also be formed in one of the second to fourth external insulating layers to expose the first or second external electrode 400 or 500.

As set forth above, according to the exemplary embodiments of the present disclosure, it is not necessary to specify the surface on which the external electrode to be formed, thereby reducing the manufacturing cost and time of the coil component.

While exemplary embodiments have been shown and described above, it will be apparent to those skilled in the art that modifications and variations could be made without departing from the scope of the present disclosure as defined by the appended claims.

What is claimed is:

1. A coil component comprising:
a body having first and second surfaces opposing each other in a thickness direction; and
a coil portion embedded within the body,
wherein the coil portion includes first and second coil patterns,
a first lead-out portion and a first dummy lead-out portion extending from the first coil pattern in the thickness direction, and respectively exposed to the first and second surfaces of the body, while being spaced apart from each other, and
a second lead-out portion and a second dummy lead-out portion extending from the second coil pattern in the thickness direction, and respectively exposed to the first and second surfaces of the body, while being spaced apart from each other.

2. The coil component of claim 1, wherein the body further has third and fourth surfaces connecting the first and second surfaces of the body to each other and opposing each other in a length direction,
and the first lead-out portion and the second dummy lead-out portion are exposed to the third surface, while being spaced apart from each other.

3. The coil component of claim 1, wherein the second lead-out portion and the first dummy lead-out portion are exposed to the fourth surface, while being spaced apart from each other.

4. The coil component of claim 3, further comprising an internal insulating layer embedded within the body between the first and second coil patterns,
wherein the first and second coil patterns are respectively disposed on one surface and other surface of the internal insulating layer.

5. The coil component of claim 4, wherein the body further has fifth and sixth surfaces connecting the first to fourth surfaces of the body to each other and opposing each other in a width direction,
the one surface of the internal insulating layer faces toward the fifth surface of the body, and
the other surface of the internal insulating layer faces to the sixth surface of the body.

6. The coil component of claim 5, wherein the internal insulating layer includes a support portion and a plurality of protrusions extending from the main portion in the thickness direction and respectively supporting the first and second lead-out portions and the first and second dummy lead-out portions and respectively exposed to the first to fourth surfaces of the body.

7. The coil component of claim 6, wherein the plurality of protrusions include the first to fourth protrusions,
the first protrusion is exposed to the surface to which the first lead-out portion of the body is exposed,
the second protrusion is exposed to the surface to which the first dummy lead-out portion of the body is exposed,
the third protrusion is exposed to the surface to which the second lead-out portion of the body is exposed, and
the fourth protrusion is exposed to the surface to which the second dummy lead-out portion of the body is exposed.

8. The coil component of claim 4, wherein the coil portion further includes a via passing through the internal insulating layer and connecting the first and second coil patterns to each other, and
a direction in which the via passes through the internal insulating layer is substantially parallel to the first to fourth surfaces of the body.

9. The coil component of claim 5, further comprising first and second external electrodes disposed on the first surface of the body, while being spaced apart from each other, and respectively connected to the first and second lead-out portions.

10. The coil component of claim 9, further comprising an external insulating layer disposed on the body to cover at least a portion of the outer surface of the body.

11. The coil component of claim 10, wherein first and second openings respectively exposing the first and second lead-out portions are formed in the external insulating layer disposed on the first surface of the body; and
the first and second external electrodes are respectively disposed in the first and second openings.

12. The coil component of claim 11, wherein the external insulating layer covers regions of the second to sixth surfaces of the body, to which the first and second lead-out portions and the first and second dummy lead-out portions are exposed.

13. A coil component comprising:
a body having first and second surfaces opposing each other in a thickness direction, and third and fourth surfaces connecting the first and second surfaces of the body to each other and opposing each other in a length direction; and
a coil portion embedded within the body,
wherein the coil portion includes first and second coil patterns,
a first lead-out portion extending from the first coil pattern in the thickness direction and exposed to each of the first and third surfaces of the body, and
a second lead-out portion extending from the second coil pattern in the thickness direction and exposed to each of the first and fourth surfaces of the body.

14. The coil component of claim 13, wherein the coil portion further includes a first dummy lead-out portion extending from the first coil pattern in the thickness direction and exposed to each of the second and fourth surfaces of the body, and
a second dummy lead-out portion extending from the second coil pattern in the thickness direction and exposed to each of the second and third surfaces of the body.

15. The coil component of claim 14, further comprising an internal insulating layer embedded within the body between the first and second coil patterns,
wherein the first and second coil patterns are respectively disposed on one surface and the other surface of the internal insulating layer.

16. The coil component of claim 15, further comprising first and second external electrodes disposed on any one of the first to fourth surfaces of the body, while being spaced apart from each other, and respectively connected to the first and second lead-out portions.

17. coil component of claim 4, wherein the one surface of the internal insulating layer is parallel to the fifth surface of the body, and
the other surface of the internal insulating layer is parallel to the sixth surface of the body.

18. The coil component of claim 5, wherein the coil portion has an axis parallel to a width direction of the body.

19. The coil component of claim 1, wherein the first and the second coil patterns have a flat spiral shape.
